(19) United States
(12) Patent Application Publication
(10) Pub. No.: US 2002/0035541 A1
(43) Pub. Date: Mar. 21, 2002

(54) System and method for providing customer-specific information and services at a self-service terminal

(76) Inventors: Katsuhiko Makino, Tokyo (JP); Akihiko Sugawara, Kanagawa (JP); Hiroyuki Tanaka, Saitama (JP); Motohiro Kochiya, Kanagawa (JP)

Correspondence Address: TOWNSEND AND TOWNSEND AND CREW, LLP, TWO EMBARCADERO CENTER, EIGHTH FLOOR, SAN FRANCISCO, CA, 94111-3834, US

(21) Appl. No.: 09/917,258

(22) Filed: Jul. 27, 2001

(30) Foreign Application Priority Data
Jul. 27, 2000 (JP) 2000-227295
Sep. 27, 2000 (JP) 2000-293496
Sep. 27, 2000 (JP) 2000-293498

(51) Int. Cl. G06F 17/60

(52) U.S. Cl. 705/43; 705/42

(57) ABSTRACT

An ATM network where customer specific display screens and services are provided to individual customers based on attribute information for those customers. Customer attribute information can include a customer name, account balance, account number, ATM transaction activity and other information about the customer. The network includes a plurality of ATMs at bank branch offices that are connected to a central accounting system of the bank, and that are separately connected to a central business system having an MCIF file server. The MCIF file server stores customer attribute information and offer information. The offer information includes data and code providing selectable ATM screen displays on promotional offers or events sponsored by the bank, and information on awards, certificates or scratch cards that may be given to customers when using an ATM. In one embodiment, the MCIF file server downloads customer service performance data (consisting of offer information and associated customer attribute information) over a digital network to an ATM monitoring apparatus at each branch office. In another embodiment, the customer service performance information is downloaded to the ATM monitoring apparatus by way of a magneto-optical disk loaded into a central office management monitoring system. In a third embodiment, the customer service performance information is downloaded at the branch office using a magneto-optical disk.

### BACKGROUND OF THE INVENTION

The present invention relates generally to a system and method for providing customers with useful customer-specific information at an automatic teller machine (“ATM”) or other self-service terminal. More particularly, the present invention relates to a method for providing information and financial service at a self-service terminal, such information and service adapted to each individual customer using the terminal.

In current banking systems, an ATM disposed at the head office or branch office of a bank performs transactions such as deposit or withdrawal of cash, transfer of funds between accounts and other similar transactions, according to the customer's operation of the ATM and the information displayed on the ATM screen. This screen displays various forms of guidance (instructions and information on use), in addition to information relating to the customer's account or the transaction being conducted.

A bank having an ATM network typically has an accounting system (at a host or central mainframe computer system) for controlling all financial transactions at the bank and its branches, and a central business system for storing and processing customer attribute information (information about each customer, such as customer name, account numbers, and prior transactions). The customer attribute information is stored in an integrated customer database file system (called a Marketing Customer Information File or “MCIF”) within the central business system. The accounting system typically runs on a host computer installed at the head office of the bank. A number of ATMs or self-service terminals are connected to the host computer through a closed or dedicated communication network. The ATMs may be disposed at bank branch offices, as well as at other locations accessible to the public, such as retail stores.

The central accounting system of a bank is provided with, for example, a secure firewall application for preventing invasion (unauthorized access) and has a duplex or redundant configuration composed of a production system and a reserved (back-up) system. Such systems are designed according to each bank's own technical configuration, in order to prevent interruption of bank transactions such as may be caused by a system breakdown or the theft or destruction of data (these examples are often considered the most serious possibilities). Because of this complexity and the sophistication of the central accounting system, even a relatively minor change within that system can generate both an enormous amount of work and a large expenditure of time and money. Therefore, changes to such accounting systems are usually kept to a minimum.

In addition, banks have recently reorganized and adopted a policy of adding no new functions to their mission-critical systems (such as the accounting system) in order to prevent complicated system changes in the event of a subsequent bank merger. Therefore, since it is a major system change for the accounting system to modify the various guidance or instruction displays at ATMs, such system changes are often avoided.

Since an ATM system is developed based on an operating system (OS), a software language, and hardware that may vary from ATM to ATM, it is difficult to change the various guide (instruction) displays on the ATMs, and thus the ATMs themselves have very little flexibility.

Since accounting system changes are avoided, and since the guidance displays at ATMs have had little flexibility, it has been difficult for branch offices to implement customized business strategies (sales, advertising, and publicity activities) using display screens at ATMs in response to customer attribute information.

The present embodiments of the invention intend to solve such problems of the prior art, and aim to provide a method for performing and obtaining a service adapted to each customer by means of an ATM, and enabling the bank to provide and the customer to receive effective financial service adapted to customer attribute information. This financial service could be implemented as a business strategy at each branch office using ATMs through an easily constructed system without changing the central accounting system of the bank in question. This invention further aims at providing a method for issuing an information card to the customer at the ATM, such card having benefit information adapted to that customer with attribute information printed on it, and providing a communication system, an information card issuing system, and an information-recording medium for the same.

### BRIEF SUMMARY OF THE INVENTION

A system and method in accordance with the present invention provides customer-specific information and services (customized or tailored to individual customers) at self-service terminals (e.g., ATMs) that are part of a network operated by a bank or other institution. The information and services are provided through the use of an ATM monitoring apparatus or system (also referred to herein as an “information processing system” or an “information distribution processing system”). The information processing system is separate from the central host computer that runs the accounting system for the bank.

In one embodiment, there is provided a data processing network having a self-service terminal and an information processing system. The information processing system is in two-way communication with the terminal. The network provides customer-specific service that is adapted to a customer conducting a transaction at the terminal. In the network, there are performed the steps of: storing, in advance of the transaction, customer service information in the information processing system, the customer service information comprising customer attribute information (information specific to the customer, such as customer name, account number, data on past transactions, account balances, and other useful customer information) and customer offer information (information useful to a plurality of customers having common or related attribute information, such as information on promotions of specific bank services, promotional events, and customer incentives); transmitting transaction-specific customer information (information identifying the customer or the transaction being conducted) from the terminal to the information processing system in response to the customer conducting a transaction at the terminal; retrieving customer offer information at the information processing system and transmitting the customer offer information to the terminal; and providing the customer offer information to the customer at the self-service terminal in response to the transaction-specific customer information.

One aspect of the present invention is characterized by the fact that the customer attribute information may include information containing a bank account number (or other account identification) and an address (e.g., physical home address) specific to each customer, and information containing a customer's transaction status.

Another aspect of the present invention is characterized by the fact that the customer offer information includes information for displaying a screen including (1) an event guide (e.g., promoting a special offer or event of interest to the customer), (2) a visit guide to a window on the administrator side (asking the customer to see a clerk or teller for assistance) or (3) offering a benefit, such as providing a gift or issuing a card for awarding points, as an incentive for using the ATM.

A further aspect of the present invention is characterized by the fact that the screen display first displays information including an event guide and a visit guide to a window on the administrator side, and then later displays a screen of selectable transaction items that can be conducted at the ATM.

Still another aspect of the present invention is characterized by displaying a standard screen (i.e., not customized for the customer) of selectable ATM transactions when it may not be possible for the network to provide customer-specific offer information, or when it may not be possible to obtain such information within a predetermined period of time.

Still another aspect of the present invention is characterized by magnifying and displaying characters and numerals on the basis of the time interval between operations when a customer uses an ATM or on the basis of the customer's age in customer attribute information (the time taken to respond, or the customer's age, indicates whether the customer can easily read the screen) or on the basis of a customer's specific magnification request made earlier to the bank.

A bank system or network of the present invention performs a service adapted to each customer and allows the customer to obtain the service through an ATM connected to an ATM information distribution processing apparatus by way of a two-way communication network. The ATM transfers transaction-specific customer information, identifying the customer or related to the ATM transaction being conducted, to the information distribution processing apparatus, and the information distribution processing apparatus transmits offer information to the customer through a screen display and/or a benefit medium output. The information distribution processing apparatus stores (in advance of the transaction) customer service information consisting of customer attribute information and customer offer information. It retrieves and transfers the offer information to the ATM on the basis of the customer attribute information.

In one embodiment, the banking system or network has a central accounting system (at a bank central office or location) for storing/controlling financial or transactional data, and a central business system (also at the same or different bank central office) for storing customer service information (customer attribute information and customer offer information). The central accounting system and the central business system are each located remotely from a bank branch office having the ATM terminal and the information processing system. The central accounting system communicates with the ATM terminal for providing transactional data and the central business system separately communicates with the ATM information distribution processing apparatus for providing (downloading and storing in advance of a transaction at the ATM terminal) customer service information.

One aspect of a system of the present invention is characterized by the fact that said information distribution processing apparatus receives and stores customer service performance information from an information-recording medium (downloaded from, e.g., a magneto-optical disk), or receives and stores customer service performance information through import (downloading) over a communication network from the central business system.

A further aspect of a system of the present invention is characterized by the fact that said customer service performance information stored in said information distribution processing apparatus through import or an information-recording medium can include programs, including applications and systems, and screen display information, including dynamic images and static images, and the programs and the screen display information are individually or collectively stored by an individual operation or a collective series of operations.

Still a further aspect of a system of the present invention is characterized by the fact that said information offer processing apparatus stores customer service performance information into an information-recording medium.

Still another aspect of a system of the present invention is characterized by the fact that said ATM has a substantially similar construction to a general-purpose small computer provided with an input device and a printer, and comprises a cash storage and input/output mechanism, a card reader for withdrawal of deposit, a font circuit storing dot fonts for magnifying and displaying characters and numerals on a screen, a passbook reader/printer that can also function to print a point awarding card or paper sheet, and a synthesized voice output means for performing voice guidance or instructions in conjunction with a displayed screen content.

A further aspect of a system of the present invention is characterized by the fact that said information distribution processing apparatus performs a reserved distribution based on a date and time/distribution reservation or a reflection reservation, and performs an immediate distribution by an individual distribution or a collective distribution.

Another aspect of a system of the present invention is characterized by the fact that said information distribution processing apparatus is provided with a database having customer attribute information stored in it, said information consisting of a customer table which is retained while an account is valid, and a visitor table. The customer table associates extracted customer data and a display message with each other. The visitor table is retained for a specified period, records customer's visit information, and updates the stored contents on that information when a customer conducts an ATM operation.

A further aspect of a system of the present invention is characterized by the fact that said information distribution processing apparatus displays that a customer is classified as having a special bank transaction status (excellent status or credit, or alternatively, bad status or credit) on the basis of the attribute information of the customer.

Another aspect of a system of the present invention is characterized by the fact that said two-way communication network containing said ATMs and information distribution processing apparatus is a network executing and communicating through the TCP/IP protocol.

A method for issuing an information card adapted to each customer by means of an ATM according to the present invention also allows the information distribution processing system to perform a service adapted to each customer. The method includes a step of first storing customer service performance information consisting of customer attribute information and offer information in advance of the ATM transaction. The next step is transferring customer transaction-specific attribute information (e.g., information identifying the customer, or relating to the specific transaction that the customer is transacting, or to the specific ATM at which the transaction is being conducted). In the next step, the information distribution processing system retrieves and transfers offer information, either in advance or in response to, the transaction-specific customer information. A further step allows the ATM to display a screen of information including an event guide and a visit guide to an administrator (or a clerk or teller), or to issue a card for providing a benefit (e.g., points, awards, or gifts) to the customer on the basis of the transaction-specific customer information. The card may be a scratch card in which the content of a benefit is revealed by rubbing specific places on the card with a coin or the like.

By this, the present invention will allow each branch office, using an ATM, to carry out their own effective business strategies, namely, sales, advertising and publicity activities to and on behalf of its customers by issuing a card having printed benefit information adapted to each customer.

An information-recording medium of the present invention is characterized by storing a program for allowing a computer to control a process of storing customer service performance information. Said information-recording medium consists of customer attribute information and offer information stored in advance into an information distribution processing apparatus that has a two-way communication with an ATM. Said information-recording medium is used in the following process: (1) transferring transaction-specific customer information to an information distribution processing apparatus when a customer uses an ATM; (2) allowing the information distribution processing apparatus to retrieve and transfer to the ATM offer information contained in customer service performance information stored on the basis of the customer attribute information; and (3) allowing the ATM to provide the transferred information to the customer in response to the transaction-specific customer information.

An information-recording medium (e.g., a magneto-optical disk) of the present invention is characterized by further storing a program which has:

(i) a process of displaying a screen of information including an event guide and a visit guide to a window of the administrator and of providing a benefit by means of a medium including the issuing of a card for awarding points;

(ii) a process of displaying a screen of information including an event guide and a visit guide to a window of the administrator and thereafter displaying a screen of selectable transaction items by means of an ATM;

(iii) a process of displaying a screen of selectable transaction items by means of an ATM in the event where it may not be possible to obtain offer information or in the event where it may not be possible to obtain offer information in a predetermined time; and

(iv) a process of magnifying and displaying characters and numerals on the basis of the time interval between operations when a customer uses an ATM or on the bases of the age of a customer in customer attribute information, or on the basis of a customer's magnification request to the bank which provides the ATM.

An information-recording medium of the present invention is further characterized by:

(a) a process of storing in it customer service performance information in advance from an information-recording medium containing an event guide and a visit guide to a window on the administrator side or storing in it customer service performance information through import (downloading) from a communication network;

(b) a process of performing a reserved distribution based on a date and time/distribution reservation or a reflection reservation, and performing an immediate distribution by an individual distribution or a collective distribution;

(c) a process of updating stored contents on the basis of a visiting customer's ATM operation; and

(d) a process of recognizing a customer classified as having a special bank transaction status on the basis of the attribute information of the customer who uses the ATM, said program allowing a computer to control at least one of said processes.

The present invention as described above easily and securely carries out effective business strategies (sales, advertising, and publicity activities adapted to customer attribute information) of each branch office, utilizing an ATM provided with a general-purpose small computer function.

A customer-specific ATM display at a branch office is provided without having to change the accounting system at the bank's central host computer. It is also possible to easily build a system by using a network environment in which there are linked together (1) an ATM which uses an operating system (OS) adaptive to a general-purpose small computer process, for example, WindowsNT (a 32-bit version of Windows OS laying emphasis on a network function) and (2) an information distribution processing apparatus.

### BRIEF DESCRIPTION OF THE DRAWINGS

FIG. 1 is a schematic diagram of a banking network, illustrating an embodiment for performing and obtaining service adapted to each customer at an ATM.

FIG. 2 is a block diagram showing the major components of the ATM in FIG. 1.

FIG. 3 is a diagram illustrating the main program and the protocol stacks in the embodiment shown in FIG. 1.

FIG. 4 is a diagram illustrating information files stored in an integrated ATM monitoring apparatus in the embodiment of FIG. 1.

FIG. 5 (consisting of FIGS. 5(a)-5(b)) is a diagram illustrating a method for registering a program and multimedia in the ATM monitoring apparatus.

FIG. 6 is a diagram illustrating the distribution of information from the integrated ATM monitoring apparatus to an ATM.

FIG. 7 is a diagram illustrating the contents stored in a database apparatus of the integrated ATM monitoring apparatus.

FIG. 8 (consisting of FIGS. 8(a)-8(e))is a diagram illustrating a sequence of screens and the downloading data between an MCIF server and the integrated ATM monitoring apparatus.

FIG. 9 is a diagram illustrating a second sequence of screens and the associated downloading of data between an MCIF server and the integrated ATM monitoring apparatus.

FIG. 10 is a diagram illustrating the functional blocks and sequence involved in creating a screen to be displayed on an ATM, by retrieving customer service performance information from the ATM monitoring apparatus.

FIG. 11 is a flowchart showing a procedure corresponding to the functional blocks and the process sequence shown in FIG. 10.

FIG. 12 is a sequence flowchart showing the information flow between the integrated ATM monitoring apparatus and an ATM.

FIG. 13 is a diagram illustrating the appearance of a display screen based on customer service performance information.

FIG. 14 (consisting of FIGS. 14(a)-14(d))is a diagram illustrating the appearance of other display screens based on customer service performance information.

FIG. 15 is a diagram illustrating the functional blocks and process sequence for issuing a scratch card on the basis of customer attribute information.

FIG. 16 is a diagram illustrating the functional blocks and sequence in the process between an ATM-LAN server and an ATM for issuing a scratch card in the embodiment.

FIG. 17 illustrates the scratch card issuing mechanism in the ATM.

FIG. 18 (consisting of FIGS. 18(a)-18(c)) illustrates a guide screen for issuing a scratch card and the contents of the scratch card.

FIG. 19 is a schematic diagram illustrating another embodiment of an ATM network in accordance with the present invention.

FIG. 20 is a schematic diagram illustrating yet another embodiment of an ATM network in accordance with the present invention.

### DETAILED DESCRIPTION OF THE INVENTION

Embodiments of a system and method for providing, at an automated teller machine (ATM), service adapted to each customer and for issuing an information card are described in detail with reference to the drawings. A communication system, an information card issuing system, and an information-recording medium for said methods according to the present invention are also described in detail with reference to the drawings.

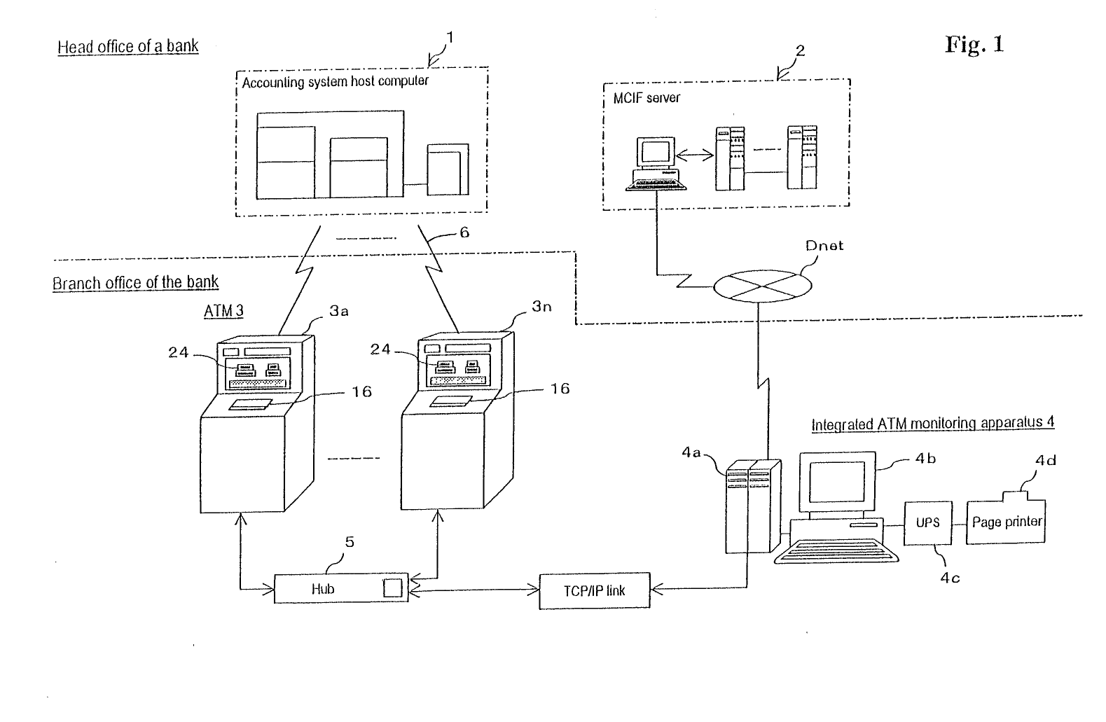

FIG. 1 illustrates one embodiment of the present invention, wherein banking services are provided to customers by a network that includes a host computer 1 having a central accounting system and a separate central business system having an MCIF (Marketing Customer Information File) server 2, both located at the bank's head office. The network further includes a plurality of ATMs 3 (3a-3n) and an integrated ATM monitoring apparatus 4 at a bank branch office, and a line concentrator or hub 5 interconnecting the ATMs to each other as well as to the ATM monitoring apparatus 4 via a link using conventional TCP/IP protocol.

The Marketing Customer Information File (MCIF) server 2 acts as an information offer processing apparatus installed at the head office of the bank (or other central location) and the integrated ATM monitoring apparatus 4 acts as an information distribution processing apparatus installed behind the counter (or in the back room) of the branch office. The ATM 3 and ATM monitoring apparatus 4 are connected through hub 5 as a local area network (10 BASE-T Standard LAN) of UNIX workstations.

In accordance with the present invention, each branch office provides service to customers on the basis of customer attribute information maintained within the MCIF server 2.

The integrated ATM monitoring apparatus 4 is provided with an ATM-LAN server 4a which terminates a digital wire circuit network Dnet (a digital public circuit network implemented by, for example, an ISDN network), uses a communications protocol over an internal bus (connected to the ATMs 3), and executes a firewall application or the like for preventing invasion (unauthorized access). The digital wire circuit network Dnet may alternatively function in the same way as an analog telephone network PSTN (Public Switched Telephone Network).

The communications protocol between the server 4a and the ATMs 3 is TCP/IP (Transmission Control Protocol/Internet Protocol) for UNIX workstations or the like.

Further, the integrated ATM monitoring apparatus 4 has a general-purpose small computer 4b (e.g., a personal computer running a Windows NT operating system) maintaining MCIF files at the branch office, an uninterruptible power supply (UPS) 4c for uninterruptibly supplying power (backed up by a battery) to the general-purpose small computer 4b, and a page printer 4d for printing out hard copy customer or systems status reports (e.g., status of the database access at apparatus 4 or status of transactions/benefits issued at the ATMs 3).

As illustrated in FIG. 1, the host computer 1 and its accounting system are connected to ATMs 3 through conventional communication lines 6, such connection being separate from the connections of the MCIF server 2 to the ATM monitoring apparatus 4 and the apparatus 4 to the ATMs 3. The accounting system host computer 1 and the integrated ATM monitoring apparatus 4 are independent of each other and do not need to perform their programmed functions in dependence on being linked to each other. In other words, in carrying out the present invention, and in particular, in providing banking services that may be uniquely adapted to customers at the bank branch office, no programming changes are needed at the host computer 1, thus eliminating the need for significant expenditures of both time and money to accomplish even a relatively minor system change.

The digital wire circuit network Dnet employs a well-known configuration and transmission method, and has a network configuration in which a digital exchange (private branch exchange: PBX) is installed. For example, it transmits IP packets at a transmission rate of 64 kbits/sec, 384 kbits/sec or 1.5 Mbits/sec. At a transmission rate of 64 kbits/sec, it performs a “2B+D” (information channels 32 kbps×2 and control channel 16 kbps) transmission by means of a packet switching procedure X.31 (I.430/I.431, Q.921/Q.931, or X.25 protocol) in conformity to ITU-T recommendations. Other high-speed transmission methods (for example, an asymmetrical digital transmission or giga-bit highspeed data communication) may also be applied.

The general-purpose small computer 4b may be a tower-type desktop personal computer or a note-type personal computer. It includes, for example, a connection device, microcomputer, flash memory, information-recording medium (CD-ROM) drive device, monitor device, input device, hard disk device, and the like, all of which are publicly known and thus not specifically shown in FIG. 1.

The ATM-LAN server 4a implements the LAN communication protocol (used in connecting the ATMs 3 to the ATM monitoring apparatus 4), and is conventional (other than for the functional features of the present invention described later) having a similar construction to the small general-purpose computer 4b.

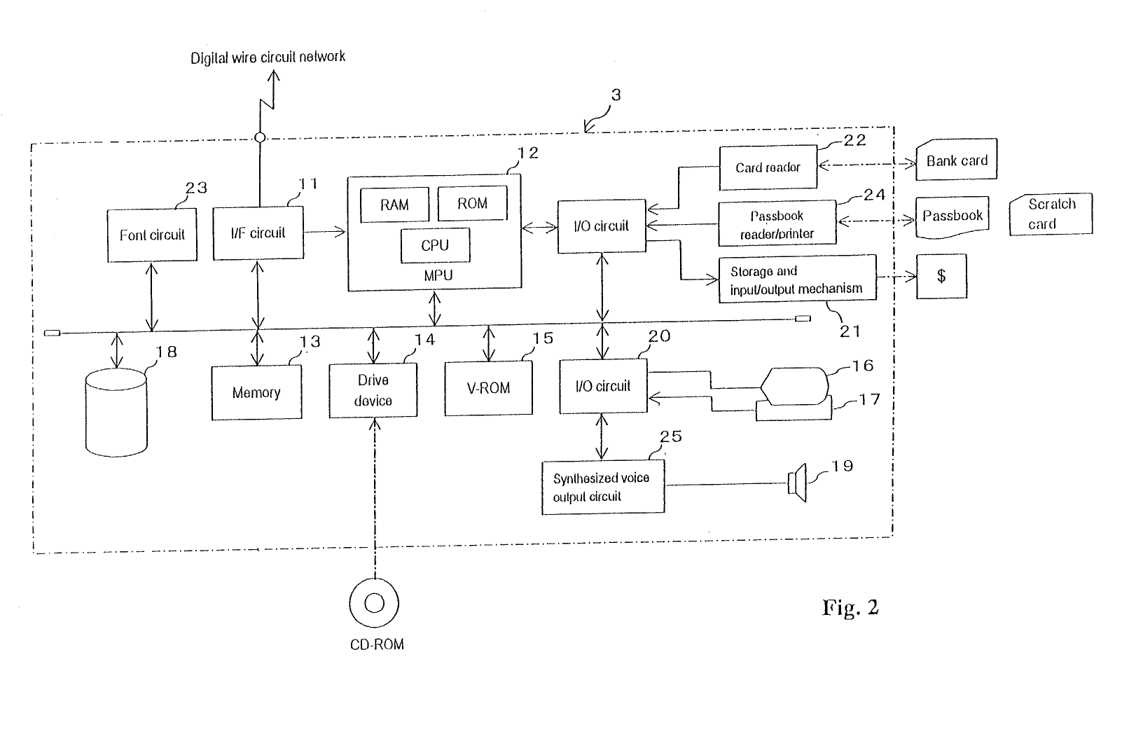

FIG. 2 is a block diagram showing the major components of an ATM 3.

In FIG. 2, the ATM 3 is also conventional (other than for the later described functional features), having many of the same components as the general-purpose small computer 4b namely, an interface (I/F) circuit 11, a microcomputer 12, a memory 13, an information-recording medium (CD-ROM) drive device 14, and a video ROM (V-ROM) 15. The ATM 3 is further provided with a color display screen device (CRT or LCD) 16 described later in relation to specific aspects (screen displays) of the present invention, an input device 17, a hard disk device 18 which provides a database and storage (for transaction-specific customer information and for offer information, all to be described later), a speaker 19 for voice output, an I/O circuit 20, a synthesized voice output circuit 25 and the like.

The color display device 16 and the input device 17 may either be integrated together into a touch panel, or alternatively, the input device 17 may be a keyboard device separate from the color display device 16.

The ATM 3 further has a cash storage and input/output mechanism 21, a card reader 22, a font circuit 23 having, for example, dot fonts stored in it for display on the ATM screen, and a passbook reader/printer 24. In accordance with the present invention, the passbook reader/printer 24 may additionally perform the function of a scratch card issuing mechanism described in more detail later in conjunction with FIGS. 15-18.

The ATM 3 and the general-purpose small computer 4b are programmed to carry out the present invention, using a communications protocol and program, executed by a CPU in each. The communications protocol and program are implemented using a general-purpose TCP/IP communications protocol program, adding to it the functional features of the present invention, to be described below.

The communications protocol and the features of the present invention may be provided as a general-purpose software package (information-recording medium such as a CD-ROM or the like) for installation at the branch office. Alternatively, the software may be stored on other information-recording medium, such as a semiconductor memory in a digital signal processor or the like, all being within the scope of the present invention.

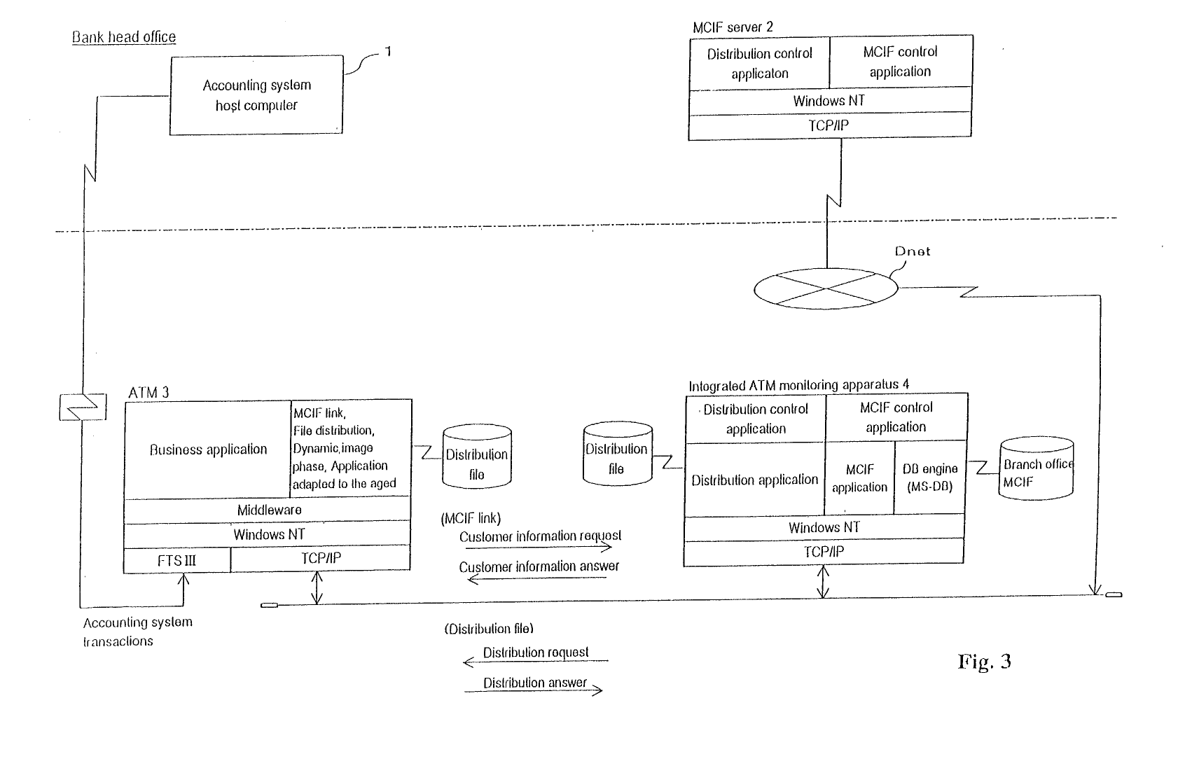

FIG. 3 is a diagram for explaining the main program and protocol stacks in the configuration shown in FIG. 1. However, before describing such program and protocol stacks, it is useful to first describe the overall operation of the network seen in FIG. 3.

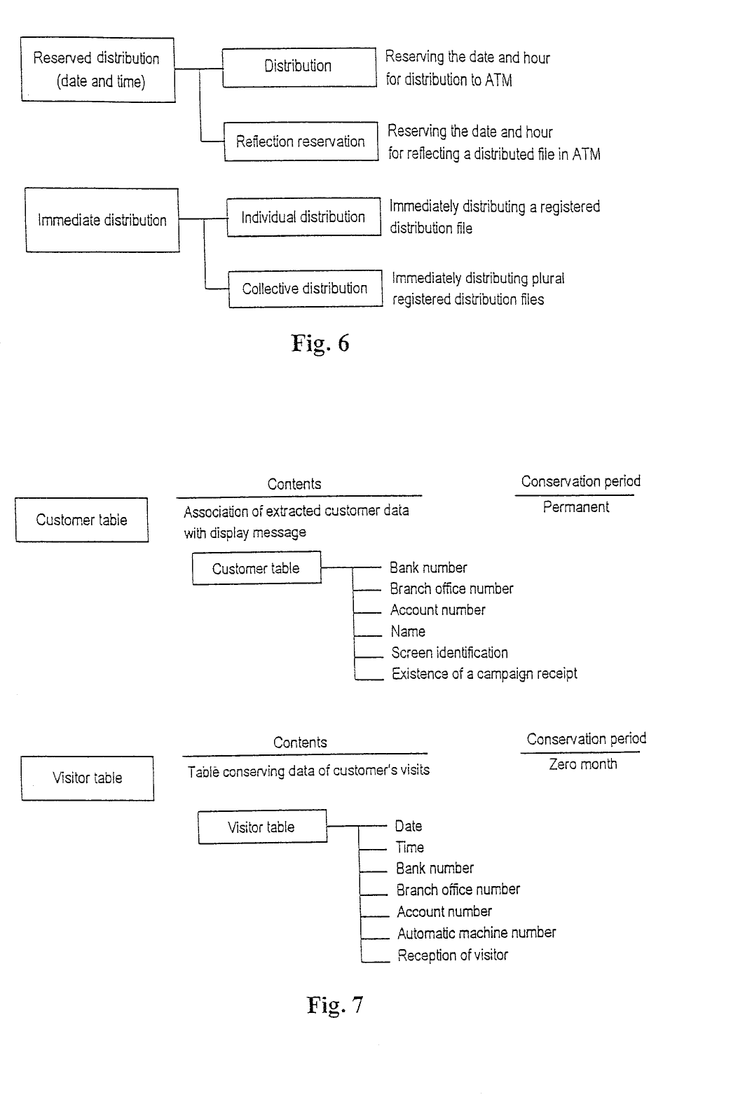

After customer service information has been downloaded from the MCIF server 2 to the monitoring apparatus 4, and the manner in which such files (distribution files) are to be transferred to the ATMs 3 has been determined (see discussion later in connection with FIG. 6), the actual display and presentation of offer information (e.g., screen displays) is accomplished by two different data flows or processes.

First, apparatus 4 transfers all selected distribution files to each of the ATMs 3 in advance. As an example, the branch office may want to make twenty different promotional displays available to customers using ATMs at that branch. The promotional or offer information (in the form of distribution files) is transferred and stored in those ATMs. This transfer of distribution files is illustrated at the bottom of FIG. 3 as the “Distribution request” (sending the distribution files) and the “Distribution answer” (acknowledging receipt of the distribution files).

Secondly, when a customer uses an ATM (and inserts his/her bankcard into the card reader), the ATM reads customer identifying data (transaction-specific customer information) from the card and sends that information (in the form a “Customer information request”)to the ATM monitoring apparatus 4 (as well as to the central accounting system at host computer 1, which handles the financial transaction of the customer, for example, after the customer sees the promotional screen and accepts or declines the promotional offer). In response to receiving the “Customer information request”, the apparatus 4 determines from stored customer attribute information which, if any, promotional displays will be presented to the customer. The apparatus 4 returns a “Customer information answer” to the ATM, instructing the ATM as to which promotional screen is to be displayed to the customer (among the twenty stored in the ATM).

Referring still to FIG. 3, the MCIF server 2 in the head office of a bank, and the integrated ATM monitoring apparatus 4 and an ATM 3 in a branch office, execute the following communications protocol and programs (1), (2), and (3).

(1) The MCIF server 2 in the head office of the bank executes:

a distribution control application (see description of distribution control application for apparatus 4),

an MCIF control application (see description of MCIF control application for apparatus 4),

an OS (WindowsNT), and

the TCP/IP (communications protocol).

(2) The integrated ATM monitoring apparatus 4 installed in the branch office executes:

the TCP/IP (communications protocol),

an OS (WindowsNT), and

Distribution Application

This application manages the transfer (distribution) of files (distribution request/distribution answer) from the integrated ATM monitoring apparatus 4/ATM-LAN server 4a) to the ATMs 3. These files are transferred as “distribution files”, as part of a process to be described later. The files to be transferred include a dynamic image file (initial screen), a first static image file (screen during transmission), a second static image file (screen specific to each customer), a telop file (initial screen), and a complete or whole bank information file. During execution of the Distribution Application, the application manages both the files to be transferred as well as the file currently in use at the ATM.

Distribution control application

This is a function enabling an administrator of the MCIF server 2 to manage the setting, registration, change, and the like of a distribution file. It is also possible to activate a distribution control application and access a distribution file by remote control from a remote place by installing this distribution control application into another terminal.

Distribution file

This distribution file storage has the file to be distributed and a file registered one generation before. That is, this file temporarily stores data (offer information and customer attribute information) to be transmitted to the ATMs. It holds both the current data being sent to the ATM (screen displays, etc.) and the data (screen displays) immediately preceding the current data.

MCIF application

This is a function which receives transaction-specific customer information (part of the “customer information request”) from an ATM 3 and retrieves customer attribute information stored in the Branch Office MCIF data base (DB) of ATM-LAN server 4a/general-purpose small computer 4b of the integrated ATM monitoring apparatus 4 (to determine if customer offer information is to be displayed at the ATM), and answers the ATM with this retrieval result (“Customer Information Answer”).

MCIF control application

This is a maintenance function used when an administrator of the integrated ATM monitoring apparatus 4 performs maintenance (deletion, addition, and update) of a customer DB or file. This MCIF control application makes it possible to activate an MCIF application and access a branch office MCIF file through remote control from a remote place by being installed into another terminal.

Branch office MCIF

This is a function for retrieving a branch office MCIF in a customer DB by means of a database engine (e.g., Microsoft DB).

(3) The ATM 3 executes:

the TCP/IP (communication protocol),

a communication application (e.g., FIS III) for transmitting data between the ATM and the accounting system,

an OS (WindowsNT)

Middleware for assimilating (and accommodating) differences in OS among the different ATMs when running applications,

Business application (for execution of transactions with the accounting system), and

MCIF-link (provides the feature of sending and receiving “Customer Information request”/“Customer information answer”), File Distribution (provides the feature of receiving distribution files and acknowledging the receipt of distribution files (“Distribution request”/“Distribution answer”), Dynamic image phase (controlling the display and sequencing of images, e.g., in the distribution file), application adapted to the aged (increase or magnify images and characters for use by sight-impaired/aged customer).

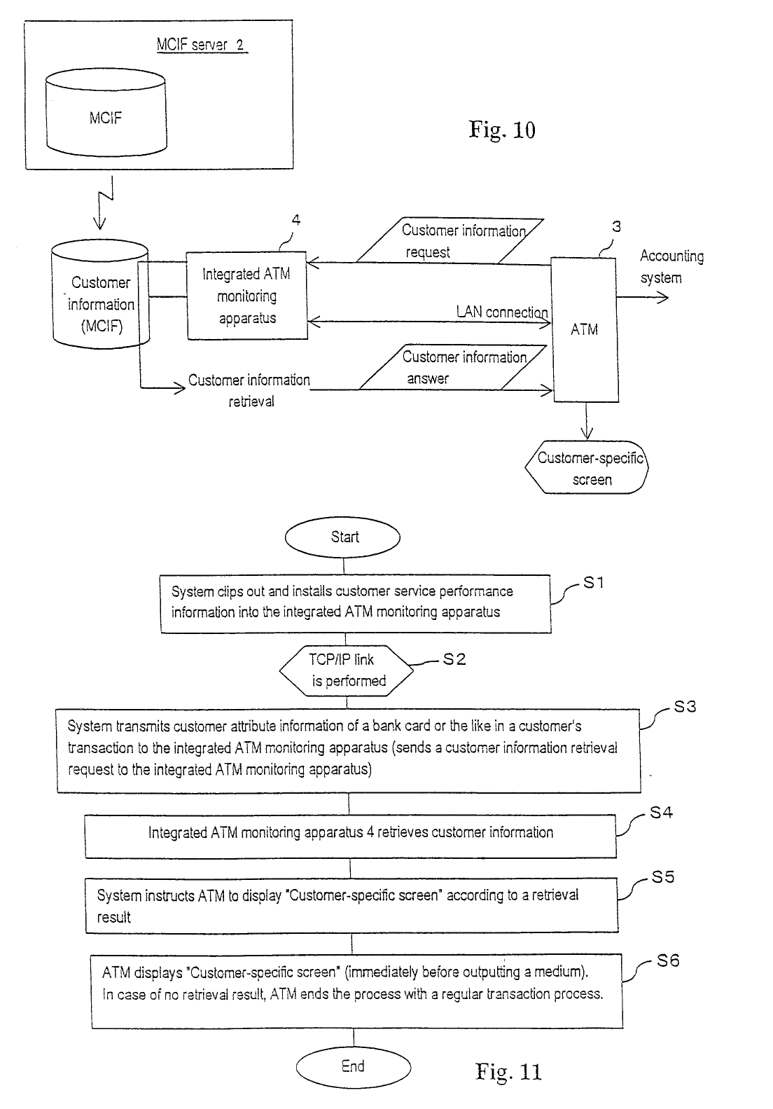

Such programs and protocol stacks in (1) to (3) listed above perform a sequence procedure for a customer information request or customer information response in an MCIF linkage, and perform a procedure of a distribution request or distribution response in a file distribution, as described below in connection with FIGS. 10 and 15.

The importing of service performance information (i.e., customer attribute information and customer offer information) adapted to a specific customer, from the MCIF server 2 to the integrated ATM monitoring apparatus 4 will now be described.

The MCIF server 2 at the head office of a bank extracts from its database a relevant customer list of each branch office. It extracts the customer's bank number, branch office number, and account number as a customer database for each of the extracted segments (conditions), sets an ATM screen number (customer offer information), and imports this customer service performance information by transferring it through the digital wire circuit network Dnet to the ATM-LAN server 4a where it is downloaded and stored in the integrated ATM monitoring apparatus 4.

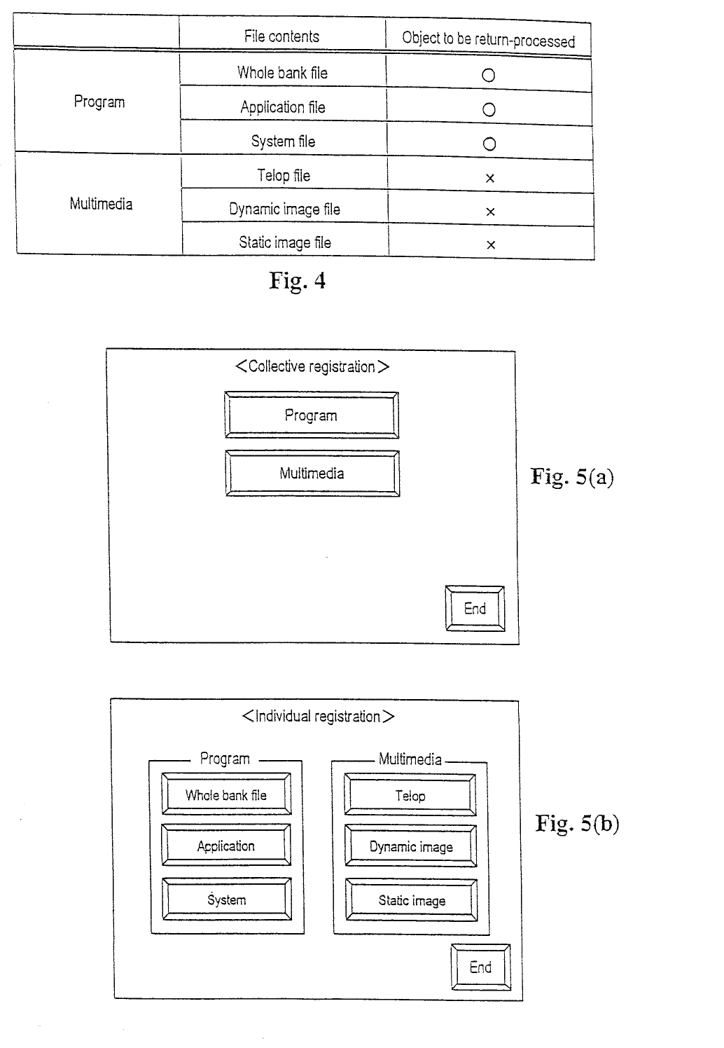

FIG. 4 illustrates the customer service performance information downloaded and installed into the integrated ATM monitoring apparatus 4.

Referring to FIG. 4, in the customer service performance information, each file of programs (code) and multimedia (display/image) is clearly expressed in relation to its content and return process. The program file is composed of a whole bank file (ID codes of all banks in a nation-wide banking association, and ID codes of individual branch offices of those banks), an application file, and a system file (an operating system on which application file will run). The multimedia file is composed of a telop file (promotional campaign information to be displayed at an ATM on a dynamic image file), a dynamic image file, and a static image file. The program file performs a process corresponding to a return process (push-pull operation) and the multimedia file performs a non-return process (push operation).

FIG. 5 (FIGS. 5(a) and 5(b)) is a diagram for explaining how to register (select and then store for use) program and multimedia files, illustrating screens on the general-purpose small computer 4b in the integrated ATM monitoring apparatus 4. These screens are used by the branch administrator to chose individual registered files (customer service information) to be made available to customers at ATMs, or, alternatively, chose to have all registered files stored in apparatus 4 available to customers at the ATMs. FIG. 5(a) is a screen for collectively selecting and registering all of the program files and/or all of the multimedia (customer service performance information) files shown in FIG. 4. FIG. 5(b) is a screen for individually selecting and registering each of the program files and the multimedia (customer service performance information) files shown in FIG. 4.

FIG. 6 is a diagram which explains the different ways that a branch office may make distribution files available for transfer/distribution from the ATM-LAN server 4a of the integrated ATM monitoring apparatus 4 to an ATM 3.

Referring to FIG. 6, the distribution includes a reserved distribution (date and time/distribution reservation, and reflection reservation) and an immediate distribution (individual distribution and collective distribution).

A distribution reservation of the reserved distribution reserves the date and time of distribution to an ATM (i.e., specifies when the file will be distributed, e.g., if a bank promotion is to be offered only at a specified time(s)), and a reflection reservation of the reserved distribution reserves the date and time for reflecting (renewing) a distributed file in an ATM (i.e., specifies a time for renewing, refreshing or updating a file previously sent to the ATM). An individual distribution of the immediate distribution makes available for immediate distribution an individual registered distribution file (i.e., as may be selected by the branch office). A collective distribution of the immediate distribution makes available for immediate distribution a plurality of registered distribution files (e.g., all files that may apply to a customer).

FIG. 7 is a diagram for explaining contents stored in the database in the integrated ATM monitoring apparatus 4.

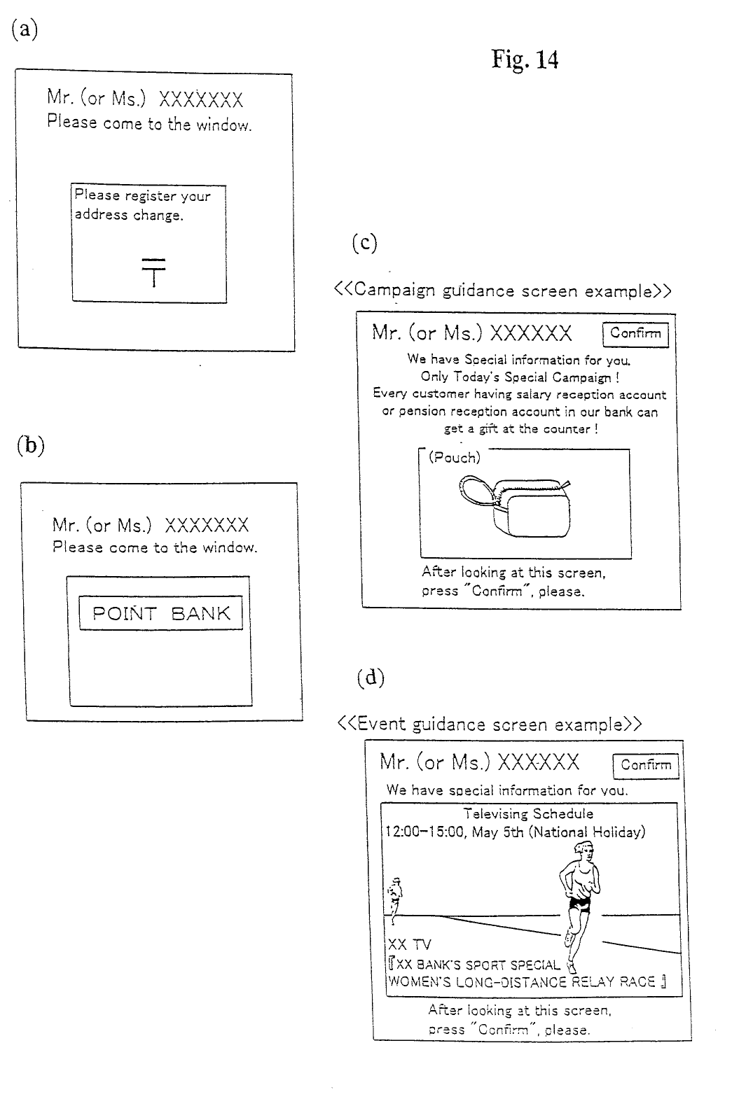

Referring to FIG. 7, the stored content consists of customer-specific attribute information in the form of a customer table and a visitor table. That is to say, it is information of a customer's ordinary transaction status and information specific to a customer. The customer table is retained permanently (so long as a customer's account is valid), associates extracted customer data with messages to be displayed, and contains a customer's bank number, branch number, account number, name, screen identification, and existence of a campaign receipt (e.g., the customer has had a promotion screen displayed and has received a promotional gift, scratch card, etc., see FIGS. 14 and 18). A visitor table is saved by apparatus 4 for a specified period of conservation, and contains a date, time, bank number, branch office number, automatic teller machine number and reception of a visitor (whether the branch manager has met or needs to personally meet with the customer). Thus, the visitor table is capable of conserving data of a customer's visits.

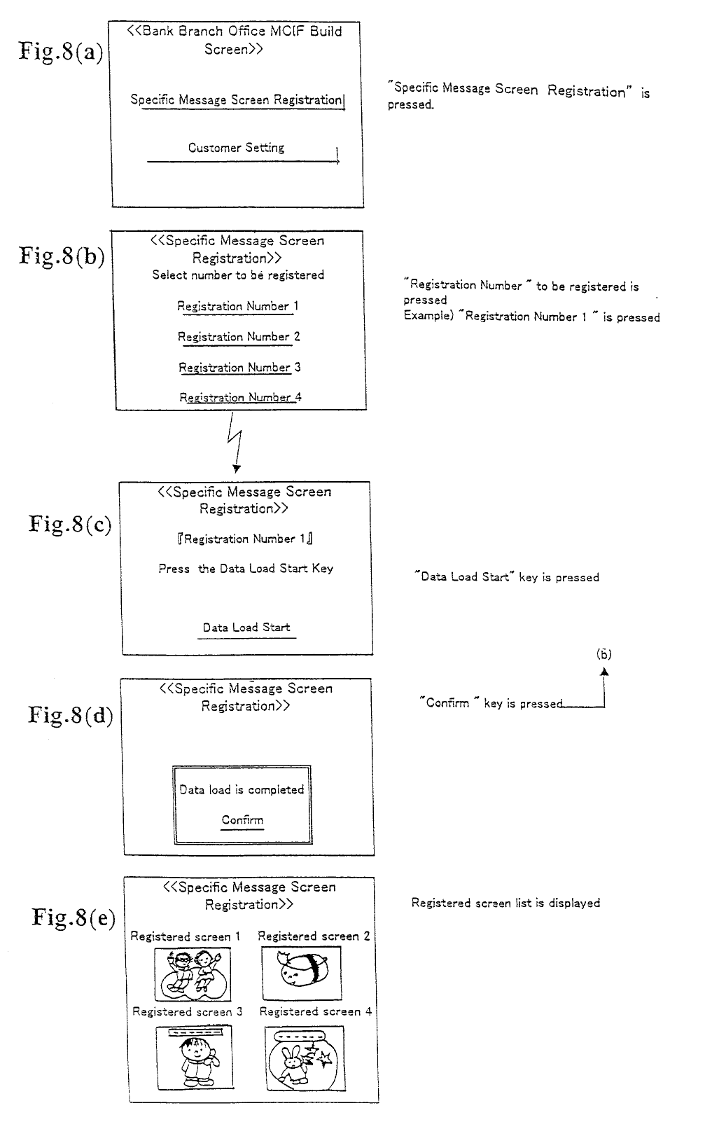

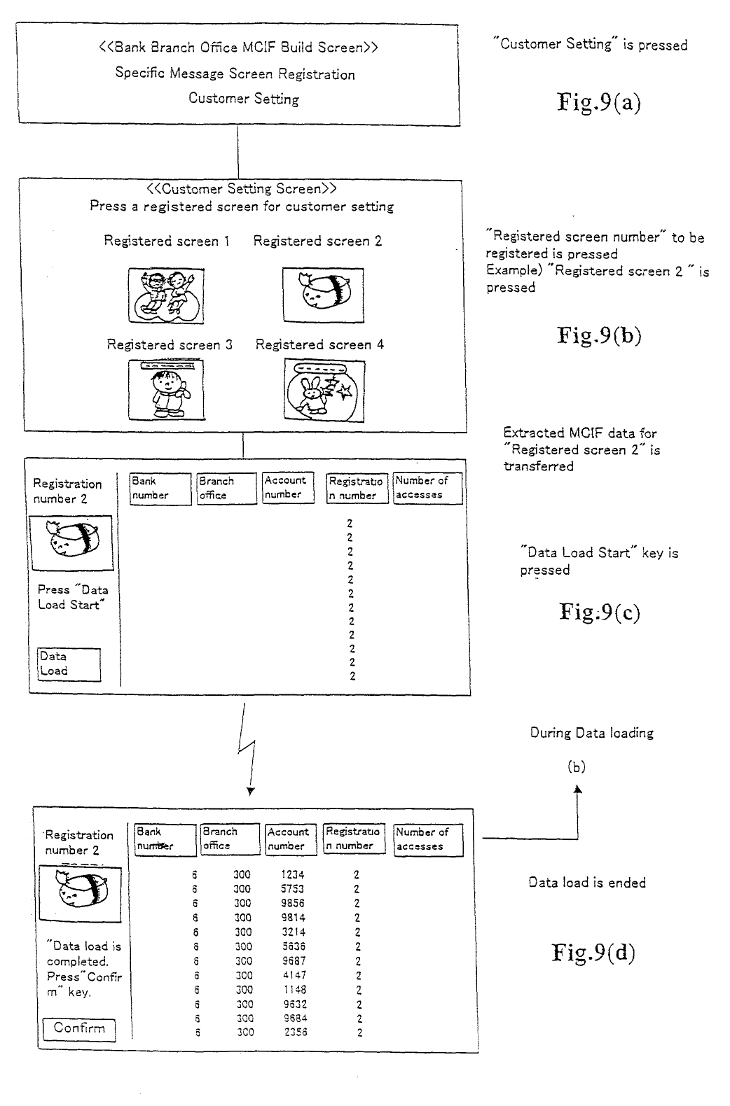

FIGS. 8 and 9 illustrate the various screens seen at the MCIF server 2 and the ATM monitoring apparatus 4 when customer service information, such as offer information (e.g., promotional display screens) and associated attribute information (e.g., customer bank account numbers)—are downloaded from MCIF server 2 to the ATM monitoring apparatus 4.

FIG. 8 (FIGS. 8(a)-8(e)) is a diagram for explaining import (downloading) of information (i.e., multimedia images, screens or screen sequences) between the MCIF server 2 and the integrated ATM monitoring apparatus 4.

In FIG. 8, this example is an import example of a specific message screen registration for building a branch office MCIF. In this import, a specific message screen registration object in an MCIF build screen (“Specific Message Screen Registration”) shown in FIG. 8(a) is selected at the MCIF server 2 in the head office of a bank.

Next, in FIG. 8(b), one of “Registration Numbers 1 to 4” being the registration number of a screen to be registered is selected at the MCIF server 2. This data is then transferred from the MCIF server 2 to the integrated ATM monitoring apparatus 4 at the branch office through the digital wire circuit network Dnet.

This transferred information (here, a screen of a selected “registration numbers 1”) is displayed and confirmed on the general-purpose small computer 4b as shown in FIG. 8(c), and is downloaded into a database (hard disk device) provided in the integrated ATM monitoring apparatus 4. Then, as shown in FIG. 8(d), its installation by download is completed. This screen (screen of “registration numbers 1 to 4”) necessary for registration of a specific message screen is repeatedly operated and downloaded. FIG. 8(e) shows a list screen as a result of having registered (selected and stored) all the screens of “registration numbers 1 to 4”. The registered screens are those that will be displayed at ATMs for that branch in providing customer-specific transactions or service.

FIG. 9 is a diagram for explaining another import between the MCIF server 2 and the integrated ATM monitoring apparatus 2.

FIG. 9 is an import example of a customer setting operation following FIG. 8, and in this import, Customer Setting in an MCIF build screen (specific message screen registration and customer setting) shown in FIG. 9(a) is selected at the MCIF server 2 in the head office of the bank.

Next, in FIG. 9(b), a screen (one of “Registration Numbers 1 to 4” in FIG. 8) is positioned and operated in the MCIF server 2. Next, as shown in FIG. 9(c), customer attribute information corresponding to the selected screen is clipped out (read from the database on server 2) and attached to the selected screen information. This data is then transferred from the MCIF server 2 to the integrated ATM monitoring apparatus 4 (ATM-LAN server 4a) of the branch office through the digital wire circuit network Dnet.

This transferred information (here, a screen of “Registration Numbers 1 to 4”) is displayed and confirmed on the general-purpose small computer 4b as shown in FIG. 9(d), and is downloaded into a database (hard disk device 18) provided in the integrated ATM monitoring apparatus 4 to complete its installation by download. A screen (in which each of “registration numbers 1 to 4” has customer attribute information attached to it) necessary for the customer setting is repeatedly selected and downloaded until all selected screens and associated customer-attribute information (e.g., account numbers) are downloaded.

The association of bank account numbers (and customers) to certain selected screens at the server 2 offers significant advantages to branch offices that want to offer customized financial services to a group of customers having certain common or related customer attributes. As one example, one of the registered screens may be a promotion for special home refinancing rates. The MCIF server 2 could be programmed to identify all customers that have attributes indicating an interest in home ownership (home buying age, already a home owner, previous application for a home loan). A branch wanting to promote home refinancing at its office could then request that the MCIF server 2 download to the ATM monitoring apparatus 4, the appropriate screen and the account numbers of all customers at that branch having those attributes (indicative of interest in home ownership).

In another example, a bank branch may want to promote a special savings plan (e.g., a certificate of deposit). Customers having savings accounts with balances high enough to potentially have an interest in that plan would be identified and their account numbers (with an appropriate promotional screen) could be downloaded to the ATM monitoring apparatus at the branch office.

FIG. 10 is a diagram for explaining an operation of clipping out customer service performance information and its associated display screen to be displayed at an ATM 3 on the basis of customer attribute information, and FIG. 11 is a flowchart showing a procedure corresponding to the process shown in FIG. 10.

In FIGS. 10 and 11, taken in conjunction with FIGS. 1, 2, 8 and 9, customer service performance information (customer attribute information and display screen information) is clipped out from the MCIF server 2 in the head office of a bank and stored in the integrated ATM monitoring apparatus 4 of a branch office through the digital wire circuit network Dnet (step S1 in FIG. 11). After this, the integrated ATM monitoring apparatus 4 (ATM-LAN server 4a) and the ATM 3 are linked (LAN-connected) to each other (step S2) by TCP/IP.

When a customer inserts a bankcard into the card reader 22 of the ATM 3 shown in FIG. 2 or inserts a passbook into a passbook reader/printer 24, the ATM 3 reads customer identifying or account information from the card. That customer ID or account information is then coupled with other transaction-specific information associated with the ATM (e.g., bank number or ID, branch office number, ATM number—see the customer and visitor tables in FIG. 7 for further examples). The ATM transfers this transaction-specific customer information to the integrated ATM monitoring apparatus 4 (step S3). That is to say, it requests retrieval of customer service performance information (“Customer Information Request”).

The integrated ATM monitoring apparatus 4 retrieves (step S4) the customer service performance information (indicating which promotional screen is to be displayed to the customer) and transfers the retrieved information of each customer to the ATM 3 (“Customer Information Answer”). The ATM displays the customer-specific screen on the color display device 16 (steps S5 and S6), such screen having been previously stored in the ATM as a distribution file, in the described embodiment. In the case where no customer service performance information can be retrieved in step S4, a standard ATM screen (not customer-specific) is displayed and a standard customer-bank transaction is performed and the process is ended.

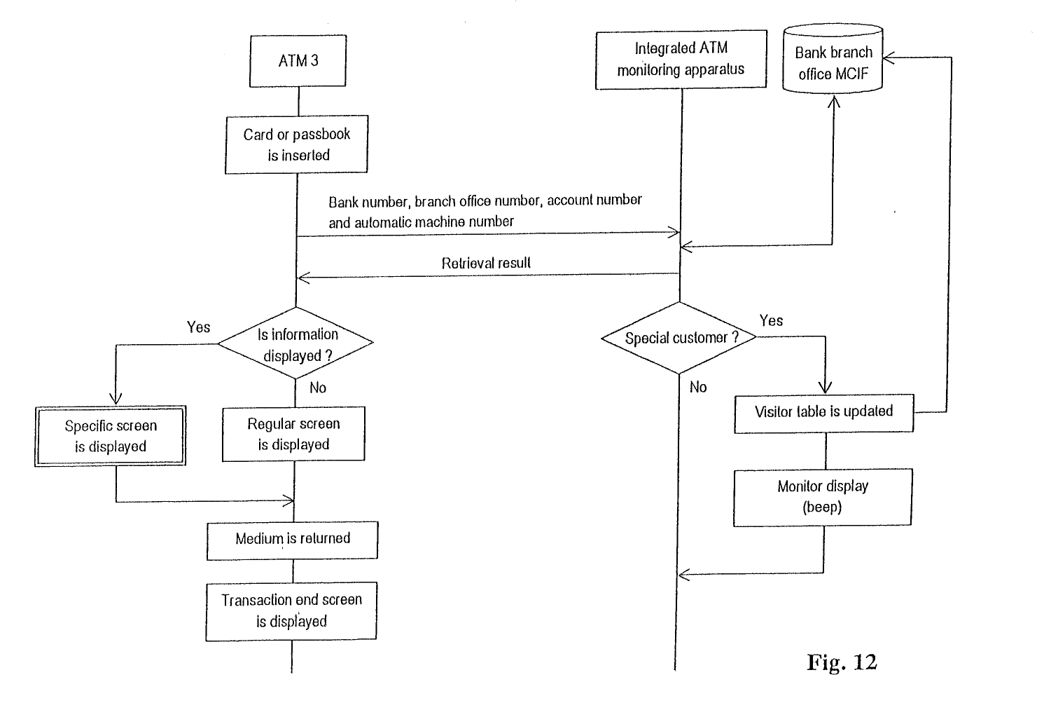

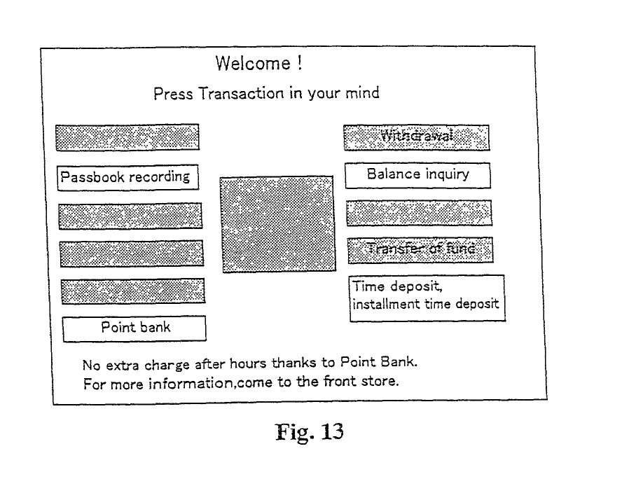

FIG. 12 is a sequence flowchart showing in greater detail the process performed between the integrated ATM monitoring apparatus 4 and the ATM 3. FIG. 13 is a diagram for illustrating one example of a display screens based on customer service performance information, and FIG. 14 is a diagram illustrating additional examples of display screens based on customer service performance information.

In FIG. 12, when a bankcard or a passbook is inserted into the ATM 3, it transfers transaction-specific customer information to the integrated ATM monitoring apparatus 4. The transaction-specific information may include a customer ID, a bank ID number, a branch office ID number, an account number, a ATM ID number and the like, as well as data identifying the transaction, such as date, time, etc. (see a customer table and a visitor table shown in FIG. 7). Then, the database engine of the integrated ATM monitoring apparatus 4 is activated. The integrated ATM monitoring apparatus 4 determines whether a specific screen display was assigned to the customer during the customer setting process (FIGS. 8 and 9). That information (“retrieval result”) is transmitted back to the ATM, and if there is a specific registered screen to be displayed for the customer account (“YES”), the ATM 3 displays the screen. If on the other hand, if the ATM monitoring apparatus 4 returns data indicating no specific screen was assigned to the customer's account (“NO”), then the ATM displays a standard or regular screen (a screen of available standard transaction items). After the display of a screen (or sequence of screens), and the transaction has been completed, the ATM returns to customer's card or passbook (medium), and a “transaction end” screen is displayed.

The integrated ATM monitoring apparatus 4, after sending the retrieval result, determines whether the customer at the ATM is classified as having a special bank transaction status. This determination is based on “reception of a visitor” field in the visitor table shown in FIG. 7. In the case where the customer is a special customer classified as having a special (e.g., excellent credit or preferred customer) bank transaction status (“Yes”), information (for example, the dates and times of visits) in the visitor table is updated. At the time of updating the visitor table, this update is monitor-displayed and is reported to an administrator of the integrated ATM monitoring apparatus 4 or to a person (customer service representative) in charge of the customer. Notification for enabling a customer service representation to quickly recognize the visit of this customer classified as having a special bank transaction status thereby enables effective business activities to be carried out. For example, the customer service representative may observe the customer to make sure that he/she is able to use the ATM without difficulty. The customer service representation may also wish to extend personal best wishes to the customer after the ATM transaction. A record of a customer classified as having a special bank transaction status is also made by a page printer 4d for later use by bank employees. In addition to a monitor display and monitor reports, notification to bank employees by audible alarm (beep) or by synthesized voice may be performed through the synthesized voice output circuit 25 and a speaker 19 at the ATM and similar output devices at other locations in the branch, e.g., near the customer service representative.

It should be appreciated that special bank status is not necessarily limited to preferred customers. For example, if a customer has bad credit, or if a customer is known to have difficulty operating an ATM, the branch may want the customer service representative notified, and the ATM to stop processing the transaction (until the customer service representative can assist the customer).

In the event the retrieval time from the apparatus 4 to the ATM 3 becomes prolonged, exceeding a predetermined fixed time, the retrieval may be stopped and a standard screen displayed. This is intended to prevent an excessive customer wait in front of the ATM 3. In such case, the transaction-specific information transferred from the ATM 3 is discarded by the integrated ATM monitoring apparatus 4 after the retrieval is stopped.

FIG. 13 shows an example of a displayed screen when a customer inserts his or her bankcard or bank note into the ATM 3. ATM 3 displays a plurality of selectable bank transaction items and a particular promotional advertisement tailor-made for the customer. The bank transactions may include, for example, a withdrawal, a balance inquiry, a transfer of funds, or a fixed time deposit having a preferential interest rate. The promotional advertisement appearing on the screen may promote after hours transactions, corresponding to the customer's attribute information (times and dates of transactions) and downloaded for specific customers of the branch, as explained earlier in connection with FIGS. 8 and 9.

A special screen shown in FIG. 14(a) displays the name of the customer at the ATM (part of attribute information downloaded to the ATM by the ATM monitoring apparatus 4) to attract their attention and guides the customer to a window where an address change may be performed. The window may be, for example, a “teller window” where a human teller (or administrator within the branch) can effect the address change, or may be a screen window on the ATM that prompts the customer to enter address information. For example, where the home address in customer attribute information and the address of the branch office being currently utilized are distant from each other, it is possible the customer has changed his/her address, and such guidance for an address change is displayed.

A special screen shown in FIG. 14(b) displays the name of a particular customer to attract their attention and guides the customer to a teller window when the customer requires special treatment. For example, if a problem has developed with the account of the customer, and the bank prefers to discuss the problem in person with the customer, the appropriate data can be put (in advance) in the customer's attribute information, and the MCIF server 2 can download the screen in FIG. 14(b) to the ATM monitoring apparatus 4, along with the account number of each customer needing an inperson meeting with the bank.

Next, a special screen shown in FIG. 14(c) displays the name of a particular customer to attract their attention to a promotional event. In this case, every customer that signs up for direct deposit, i.e., “transfer of salary to their bank account” or “reception of pension by their bank account,” is eligible for a gift displayed on the screen.

Further, a special screen shown in FIG. 14(d) displays the name of a particular customer to attract his attention and provides information on an upcoming event activity (in this example, TV broadcasting of a women's long-distance relay race). Again, the screens displayed are directed to specific customers based on the attribute information stored in the MCIF server 2.

In accordance with the present invention, an ATM network can also use customer attribute information to issue cards and certificates that provide incentives/awards to customers. For example, if the branch office wants to encourage certain customers (based on their attribute information) to more frequently use its ATMs, it can issue scratch cards or game cards to those customers when they conduct ATM transactions.

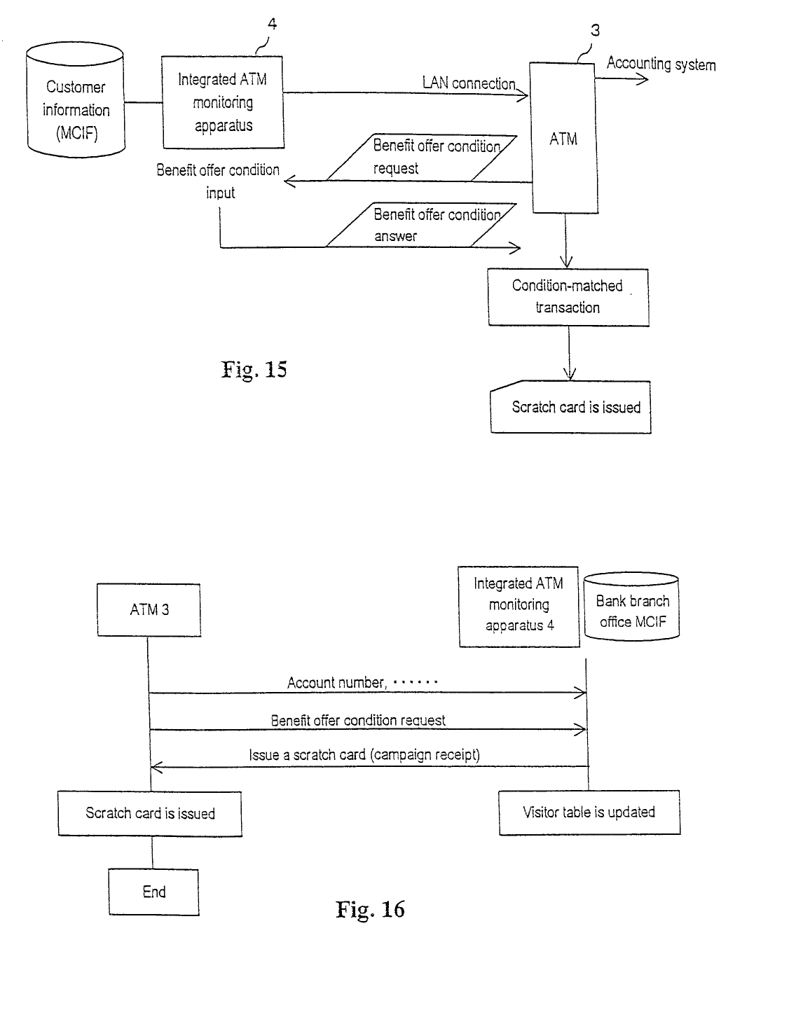

For purposes of illustrating the issuance of cards/certificates in an ATM network, FIG. 15 shows the overall process performed between the integrated ATM monitoring apparatus 4 and the ATM 3, and FIG. 16 shows the same process in a slightly different form.

Referring to FIGS. 15 and 16, when a customer inserts a bankcard into a card reader 22 of the ATM 3 or inserts a passbook into a passbook reader/printer 24 of the ATM 3 (FIG. 2), ATM 3 captures transaction-specific customer information (e.g., a bank number, branch office number, account number customer identification and the like), and transfers this information to the integrated ATM monitoring apparatus 4. The transfer of this information is shown in the drawings as a “benefit offer condition request command,” which is the same as the “customer information request” command in FIG. 3.

The integrated ATM monitoring apparatus 4 receives the “benefit offer condition request” and, in the case where the issuance of a scratch card is indicated by the customer attribute information for the customer, the apparatus 4 instructs the ATM 3 to issue a scratch card (the information so instructing the ATM is the “benefit offer condition answer,” which is the same as the “customer information answer” in FIG. 3). The ATM 3 updates the information related to the customer in the visitor table shown in FIG. 7, indicating that a scratch card (campaign receipt) has been issued and received by that customer.

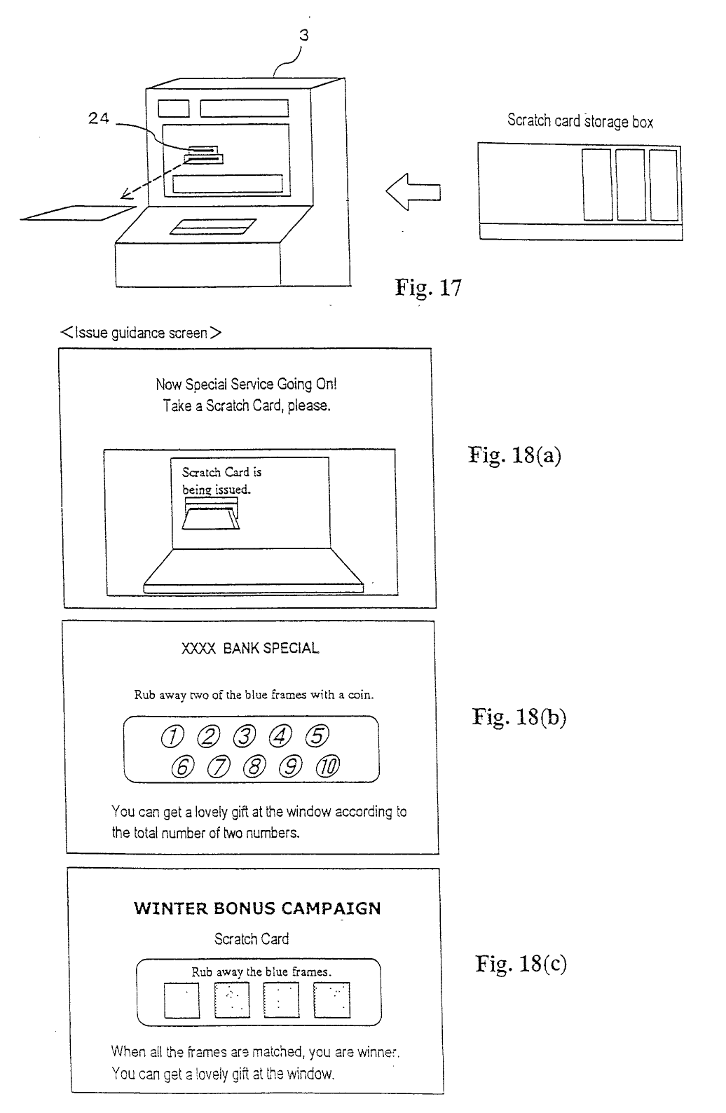

FIG. 17 illustrates the issuance of a scratch card at the ATM.

Referring to FIG. 17, the scratch card issuing mechanism can either be a conventional card/ticket printing device connected to the ATM or can be part of the passbook reader/printer 24 shown in FIGS. 1 and 2, and has a scratch card storage box disposed inside the ATM 3 and is provided with a printing head and a carrying mechanism. It outputs (issues to a customer) a scratch card having, for example, the announcement of a current bank promotional campaign printed on it.

FIG. 18 is a diagram illustrating a guidance screen display at the ATM when issuing a scratch card, and the appearance of several scratch cards that could be issued.

FIG. 18(a) shows a screen that might appear on the ATM display when the ATM 3 is issuing a scratch card. FIG. 18(b) shows an exemplary scratch card, with the customer being instructed to rub surfaces for revealing a total number of points that may entitle the customer to redeem the card for a promotional gift at a teller window (as part of a “Bank Special” promotion campaign).

FIG. 18(c) shows an exemplary scratch card issued as part of a “Winter Bonus Campaign,” for example, as an incentive to make deposits, and if all the parts whose surfaces are rubbed away on the scratch card match, a gift can be claimed at a teller window.

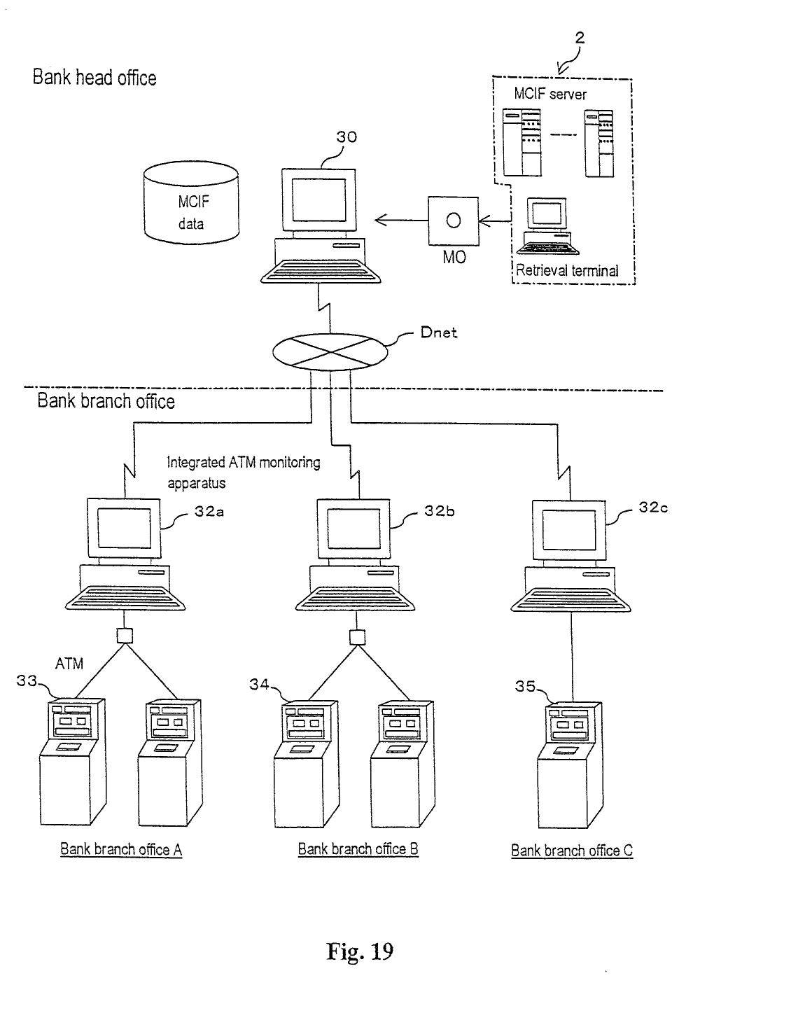

FIG. 19 illustrates a second embodiment of an ATM network in accordance with the present invention.

Referring to FIG. 19, the network lightens the load on the MCIF server 2 in the head office of a bank and eliminates the need for a direct, on-line communication when customer service information is downloaded to branch offices A, B, and C. A management monitor apparatus 30 for this purpose is installed in the head office of the bank.

A retrieval terminal (general-purpose small computer) of the MCIF server 2 retrieves customer service performance information from the server 2 and stores it on an external information-recording medium, such as a magneto-optical (MO) disk. As in the network of FIG. 1, the customer service performance information stored on the MO disk includes customer attribute information (e.g., customer account number) and offer information (customer-specific screen displays or awards/benefits). The customer service performance information is downloaded and installed from the external information-recording medium into the management monitor apparatus 30.

Each of integrated ATM monitoring apparatuses 32a, 32b and 32c respectively provided at the branch offices A, B, and C selectively transfers a request command to the management monitor apparatus 30 and takes in customer service performance information. Thereafter, the network performs the same operations as described earlier in connection with FIGS. 1 through 18.

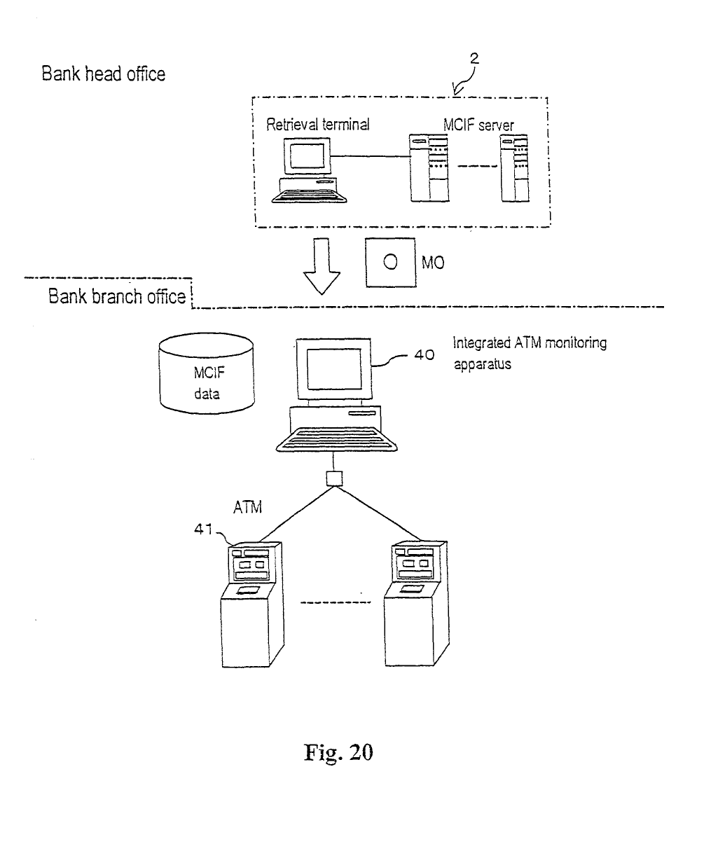

FIG. 20 is illustrates a third embodiment of an ATM network in accordance with the present invention.

In FIG. 20, customer service performance information is downloaded to ATM monitoring apparatus 4 without using a digital wire circuit network Dnet. A retrieval terminal (general-purpose small computer) of an MCIF server 2 retrieves and stores customer service performance information onto an external information-recording medium, such as magneto-optical (MO) disk. The MO disk is taken to a branch office, where the information is downloaded and imported into an integrated ATM monitoring apparatus 40 (corresponding to the integrated ATM monitoring apparatus 4 in FIG. 1). Thereafter, the network performs the same operations as described in FIGS. 1 through 18, providing customer service performance information to ATMs 41.

As described above, an ATM network or system having ATMs and an integrated ATM monitoring apparatus, interconnected for communicating using TCP/IP protocol in a branch office, may have customized and customer-specific screen displays without changing or reprogramming an accounting host computer system 1. Such a system can be easily and securely built in a network environment in which ATMs and the integrated ATM monitoring apparatus are linked with each other by applying an operating system (for example, WindowsNT) adaptive to a general-purpose small computer process to the ATMs 3.

The system herein enables each branch office to provide customer-specific service based on customer attribute information.

As is apparent from the above description, a method for performing and obtaining a service adapted to each customer using an ATM, and a communication system and an information-recording medium for it according to the present invention has the effect of making it possible for each branch office to easily and securely carry out their own branch specific business strategies, such as by providing customer-specific screens pertaining to promotions and other activities of interest to specific groups or categories of customers.

While a detailed description of exemplary embodiments has been given above, various alternatives, modifications, and equivalents will be apparent to those skilled in the art without varying from the spirit of the invention. Therefore, the above description should not be taken as limiting the scope of the invention, which is defined by the appended claims.

What is claimed is:

1. In a data processing network having a self-service terminal and an information processing system, the information processing system in two-way communication with the terminal, a method for providing customer-specific service that is adapted to a customer conducting a transaction at the terminal, said method comprising:
storing, in advance of the transaction, customer service information in the information processing system, the customer service information comprising
customer attribute information associated with that customer, and
customer offer information used for implementing a customer-specific service for that customer;
retrieving customer offer information at the information processing system and transmitting the customer offer information to the terminal;
transmitting transaction-specific customer information from the terminal to the information processing system in response to the customer conducting a transaction at the terminal; and
providing the customer offer information to the customer at the self-service terminal in response to the transaction-specific customer information.

2. The method of claim 1, wherein the self-service terminal is an automated teller machine (ATM).

3. The method of claim 1, wherein the customer attribute information comprises information identifying either one or both of (a) particular personal attributes of the customer and (b) attributes of an account maintained for the customer.

4. The method of claim 3, wherein the customer attribute information further comprises data identifying the bank account of the customer

5. The method of claim 3, wherein the customer attribute information further comprises the address of the customer.

6. The method of claim 3, wherein the customer attribute information further comprises data relating prior transactions conducted by the customer.

7. The method of claim 3, wherein the customer attribute information further comprises data identifying whether the customer is sight-impaired and wherein the customer offer information operates the terminal so as to increase the size of transaction information displayed on the terminal.

8. The method of claim 3, wherein the customer attribute information stored in the information processing system further comprises data identifying the age of the customer and wherein the customer offer information operates the terminal so as to increase the size of transaction information displayed on the terminal.

9. The method of claim 3, wherein the customer attribute information comprises data identifying the customer as having a special customer status.

10. The method of claim 9, wherein the customer offer information comprises data causing the information processing system to notify a human administrator of the special customer status.

11. The method of claim 9, wherein the special customer status is a preferred customer status.

12. The method of claim 9, wherein the special customer status is a poor credit status.

13. The method of claim 9, wherein the customer offer information comprises display information to be displayed at the terminal and directing the customer to a human administrator.

14. The method of claim 2, wherein the customer offer information comprises information for implementing a customer-specific service to a plurality of customers having related customer attribute information.

15. The method of claim 14, wherein the terminal dispenses a card to the customer and wherein the customer offer information comprises display information to be printed on the card by the terminal.

16. The method of claim 14, wherein the customer offer information further comprises display information of potential interest to a plurality of customers having related customer attribute information, said display information comprising:
promotion display information relating to a promotional event of potential interest to the customers.

17. The method of claim 16, wherein the customer offer information further comprises:
administrator display information having instructions for directing the customers to a human administrator for further action in connection with the promotional event.

18. The method of claim 17, wherein the customer offer information further comprises:
game display information to be printed on a game card dispensed at the terminal, the game card having portions to be rubbed away to reveal information relating to game awards.

19. The method of claim 18, wherein the customer offer information further comprises:
transaction display information on one or more transactions that may be selected by the customers and then conducted at the terminal.

20. The method of claim 19, wherein the transaction display information displays information concerning standard transactions that are applicable to all customers who may use the terminal, and such transaction display information is displayed when none of the promotion display information, the administrator display information and game display information is transmitted by the information processing system to the terminal.

21. The method of claim 19, wherein the transaction display information is displayed when the promotion display information, the administrator display information and the game display information is not displayed to the customer within a predetermined period of time after initiating a transaction at the terminal.

22. The method of claim 1, wherein the transaction-specific customer information transmitted from the terminal comprises data identifying the customer.

23. The method of claim 22, wherein the transaction-specific customer information transmitted from the terminal further comprises data identifying the type of transaction being conducted by the customer.

24. The method of claim 22, wherein the transaction-specific customer information transmitted from the terminal further comprises data identifying an account of the customer.

25. The method of claim 1, wherein the data processing network is a bank automated teller machine (ATM) network, wherein the terminal is an ATM, wherein the data processing network further comprises a central accounting system for controlling financial transactions in the network and a separate central business system for storing customer service information, wherein the central accounting system and the central business system are each located remotely from the terminal and the information processing system, and wherein the step of storing customer service information in the information processing system includes the step of downloading customer service information from the central business system to the information processing system.

26. The method of claim 25, wherein the central accounting system is connected to the terminal and wherein the central business system is separately connected to the information processing system,

27. The method of claim 25, wherein the step of downloading customer service information from the central business system comprises the steps of storing the customer service information on information-recording medium, and then installing the information-recording medium at the information processing system.

28. A data processing network, comprising:
a plurality of self-service terminals providing customer-specific service to a customer conducting transactions at the terminals; and
an information processing system connected in two-way communication with the terminals;
wherein the self-service terminals transmit transaction-specific customer information from the terminals to the information processing system in response to a customer initiating a transaction at the terminals;
wherein the information processing system stores customer service information in advance of transactions, the customer service information comprising
customer attribute information related to attributes of the customer, and
customer offer information that implements a customer-specific service for the customer and that is associated with the customer attribute information; and
wherein the information processing system retrieves and transmits the customer offer information to the terminals, and
wherein the terminal provides the customer offer information that terminal to a customer having associated attributes, in response to the transaction-specific customer information.

29. The network of claim 28, wherein the data processing network is a bank automated teller machine (ATM) network, wherein the terminals are ATMs, wherein the data processing network further comprises a central accounting system for storing transactional data and a separate central business system for storing customer service information, wherein the central accounting system and the central business system are each located remotely from the terminals and the information processing system, and wherein customer service information is stored in advance in the information processing system by downloading the customer service information from the central business system to the information processing system.

30. The network of claim 29, wherein the central accounting system is connected to the terminals and wherein business system is separately connected to the information processing system for downloading the customer's service information.

31. The network of claim 29, wherein the central business system downloads the customer service information on information recording medium, and wherein the information-recording medium is installed on the information processing system.
